(19) United States
(12) Patent Application Publication
(10) Pub. No.: US 2026/0011348 A1
(43) Pub. Date: Jan. 8, 2026

(54) RECORD AND REPLAY CONTROL DEVICE, REPLAY CONTROL METHOD, AND STORAGE MEDIUM

(71) Applicant: JVCKENWOOD Corporation, Yokohama-shi (JP)

(72) Inventors: Yasutoshi Sakai, Yokohama-shi (JP); Keita Hayashi, Yokohama-shi (JP)

(21) Appl. No.: 19/325,602

(22) Filed: Sep. 11, 2025

Related U.S. Application Data
(63) Continuation of application No. PCT/JP2023/037678, filed on Oct. 18, 2023.

(30) Foreign Application Priority Data
Sep. 3, 2024 (JP) 2024-552391
Mar. 22, 2023 (JP) 2023-045657

(51) Int. Cl. G11B 27/34; H04N 5/77

(52) U.S. Cl. CPC G11B 27/34; H04N 5/77

(57) ABSTRACT

A record and replay control device includes an image capturing control unit that acquires a video image that has been captured by a rear camera, a range identification unit that identifies a first range that is to be displayed on a first display unit and that is used by a driver of the vehicle to check the rear of the vehicle with respect to the video image acquired by the image capturing control unit, a recording control unit that records the video image acquired by the image capturing control unit in a recording unit, a replay control unit that replays the video image recorded by the recording control unit, and a display control unit that displays, when the video image replayed by the replay control unit is displayed on the first display unit or a second display unit that is different from the first display unit in a second range that is larger than the first range, information that indicates the first range on the video image that is displayed in the second range.

### CROSS-REFERENCE TO RELATED APPLICATIONS

This application is a Continuation of PCT International Application No. PCT/JP2023/037678 filed on October 18, 2023 which claims the benefit of priority from Japanese Patent Application No. 2023-045657, filed on March 22, 2023 and Japanese Patent Application No. 2024-552391, filed on September 3, 2024, the entire contents of both of which are incorporated herein by reference.

### BACKGROUND OF THE INVENTION

### 1. Field of the Invention

The present invention relates to a record and replay control device, a replay control method, and a program.

### 2. Description of the Related Art

A drive recorder that is also used as a digital inner mirror is becoming popular (for example, see Japanese Laid- open Patent Publication No. 2022-058355). This type of drive recorder includes at least a front camera and a rear camera, records video images captured by the front camera and the rear camera, and causes a display unit having the same size as that of the rearview mirror to display the video image captured by the rear camera, whereby the drive recorder functions as the digital inner mirror.

A camera that captures video images and that is used to record the captured video images as a drive recorder is required to capture a wide range of images, and therefore, a camera with a relatively wide angle of view is used. In contrast, regarding a range to be displayed as a digital inner mirror, if the video image captured by a wide angle camera is displayed as it is, the angle of view is wide, and therefore, objects located in the range needed to be checked are accordingly displayed in a small size, so that there may be a case in which an appropriate check is not performed. Accordingly, the video image to be displayed on the digital inner mirror displays a narrow range of the video image obtained by partially cutting out the video image captured by the rear camera.

As a result of this, in a case where a video image, such as a video image stored as event data on the basis of an occurrence of an event, such as an accident, that has been recorded as a video image of the drive recorder is replayed, an angle of view of a display range of a rear view video image that has been recorded by the rear camera and an angle of view of a range that is actually checked by a driver of a vehicle by using the digital inner mirror are different. Furthermore, a display size of a different vehicle or the like that is being checked by the driver of the vehicle by using the digital inner mirror and a display size of the different vehicle that is being displayed on the replayed rear view video image are also different, so that there may be a case in which it is difficult for the driver of the vehicle to appropriately provide an explanation of the circumstances at the time of an occurrence of an accident on the basis of the replayed rear view video image.

### SUMMARY OF THE INVENTION

It is an object of the present invention to at least partially solve the problems in the conventional technology.

The above and other objects, features, advantages and technical and industrial significance of this invention will be better understood by reading the following detailed description of presently preferred embodiments of the invention, when considered in connection with the accompanying drawings.

A record and replay control device according to the present disclosure comprising: an image capturing control unit that acquires a video image that has been captured by a rear camera that captures an image of a rear of a vehicle; a range identification unit that identifies a first range that is to be displayed on a first display unit and that is used by a driver of the vehicle to check the rear of the vehicle with respect to the video image acquired by the image capturing control unit; a recording control unit that records the video image acquired by the image capturing control unit in a recording unit; a replay control unit that replays the video image recorded by the recording control unit; and a display control unit that displays, when the video image replayed by the replay control unit is displayed on the first display unit or a second display unit that is different from the first display unit in a second range that is larger than the first range, information that indicates the first range on the video image that is displayed in the second range.

A replay control method that is executed by a replay device, the replay control method according to the present disclosure comprising: a replay control step of replaying a video image that has been captured and recorded by a rear camera that captures an image of a rear of a vehicle; and a display control step of displaying, when the video image replayed at the replay control step is displayed on a first display unit that displays the video image in a first range in order for a driver of the vehicle to check the rear of the vehicle or is displayed on a second display unit that is different from the first display unit in a second range that is larger than the first range, information that indicates the first range on the video image.

A non-transitory computer-readable storage medium storing a program causing a computer according to the present disclosure to execute: a replay control step of replaying a video image that has been captured and recorded by a rear camera that captures an image of a rear of a vehicle; and a display control step of displaying, when the video image replayed at the replay control step is displayed on a first display unit that displays the video image in a first range in order for a driver of the vehicle to check the rear of the vehicle or is displayed on a second display unit that is different from the first display unit in a second range that is larger than the first range, information that indicates the first range on the video image.

### BRIEF DESCRIPTION OF THE DRAWINGS

FIG. 1 is a block diagram illustrating an example of a configuration of an on-vehicle record and replay device that includes a record and replay control device according to a first embodiment;

FIG. 2 is a front view illustrating a first display unit;

FIG. 3 is a rear view illustrating the first display unit;

FIG. 4 is a diagram illustrating one example of an image capturing angle of view of a rear camera and a first range;

FIG. 5 is a block diagram illustrating an example of a configuration of a replay device that includes a replay control device according to the first embodiment;

FIG. 6 is a front view illustrating a second display unit;

FIG. 7 is a flowchart illustrating the flow of a recording process performed in the record and replay control device according to the first embodiment;

FIG. 8 is a flowchart illustrating the flow of a replay process performed in the record and replay control device according to the first embodiment;

FIG. 9 is a diagram illustrating one example of a video image in which the first range is drawn in the second display unit;

FIG. 10 is a diagram illustrating another example of a video image in which the first range is drawn in the first display unit;

FIG. 11 is a block diagram illustrating an example of a configuration of an on-vehicle record and replay device that includes a record and replay control device according to a second embodiment;

FIG. 12 is a front view illustrating a first display unit and a line of sight detection camera;

FIG. 13 is a flowchart illustrating the flow of a recording process performed in a record and replay control device according to the second embodiment;

FIG. 14 is a flowchart illustrating the flow of a replay process performed in the record and replay control device according to the second embodiment;

FIG. 15 is a flowchart illustrating the flow of a recording process performed in a record and replay control device according to a third embodiment; and

FIG. 16 is a flowchart illustrating the flow of a replay process performed in the record and replay control device according to the third embodiment.

### DETAILED DESCRIPTION OF THE PREFERRED EMBODIMENTS

Hereinafter, preferred embodiments of a record and replay control device, a replay control method, and a program according to the present disclosure will be explained with reference to accompanying drawings. Furthermore, the present invention is not limited to the embodiments described below.

### First Embodiment

### Record and replay device

A record and replay device may be implemented as a single unit of an on-vehicle record and replay device 10 that is a drive recorder with a digital inner mirror type having a recording and replaying function. Alternatively, the record and replay device may be implemented as a record and replay system that includes both of the on-vehicle record and replay device 10 that is the drive recorder with the digital inner mirror type having at least a recording function and a replay device 50, such as a navigation device that replays the video image recorded by the on- vehicle record and replay device 10, a smartphone, or a personal computer (PC). In the descriptions below, the descriptions will be given by assuming that the record and replay device is implemented as the record and replay system that includes the on-vehicle record and replay device 10 and the replay device 50.

### On-vehicle record and replay device

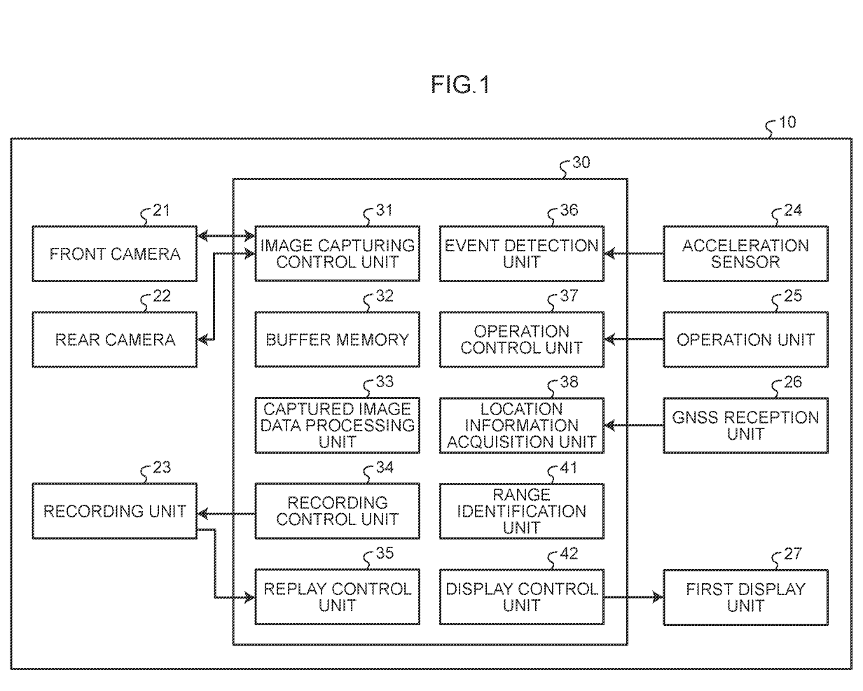

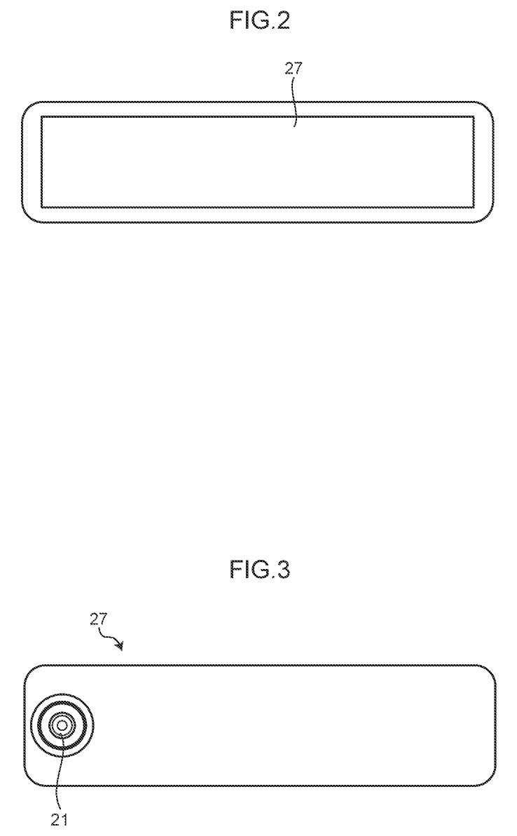

FIG. 1 is a block diagram illustrating an example of a configuration of an on-vehicle record and replay device including a record and replay control device according to a first embodiment. FIG. 2 is a front view illustrating a first display unit. FIG. 3 is a rear view illustrating the first display unit.

In the present embodiment, the on-vehicle record and replay device 10 is implemented as a drive recorder that is integrated with a digital inner mirror. The on-vehicle record and replay device 10 has a function of the drive recorder, in addition to the function serving as the digital inner mirror. In the present embodiment, the on- vehicle record and replay device 10 is fixed to a windshield (not illustrated) or an inner mirror. The on- vehicle record and replay device 10 may be a device that is installed in a vehicle or may be a portable device that is available for use in the vehicle. The on-vehicle record and replay device 10 includes a front camera 21, a rear camera 22, a recording unit 23, an acceleration sensor 24, an operation unit 25, a Global Navigation Satellite System (GNSS) reception unit 26, a first display unit 27, and a record and replay control device 30.

The front camera 21 is a camera that captures images of the front of the vehicle. In the present embodiment, the front camera 21 is described as a camera capable of capturing images in a range of about 140 degrees to 160 degrees in a horizontal direction, and in a range of about 60 degrees to 80 degrees in a vertical direction, but the embodiments are not limited to this example, and it may be possible to adopt a camera that is able to capture a 360- degree spherical image or a plurality of camera groups that capture images in different directions. The front camera 21 is arranged on a front part inside the vehicle. As illustrated in FIG. 2 and FIG. 3, the front camera 21 is arranged on the back side of the first display unit 27. The front camera 21 continuously captures video images during a time period from start to stop of a power source, such as an engine, of the vehicle, that is, during a time period in which the vehicle is in operation. In the present embodiment, the front camera 21 continuously captures video images while an accessory power supply of the vehicle is turned on. The front camera 21 outputs the captured video images to an image capturing control unit 31 included in the record and replay control device 30. The video images captured by the front camera 21 are a moving image formed of images at, for example, 30 frames per second.

The rear camera 22 is a camera that captures images of the rear of the vehicle. In the present embodiment, the rear camera 22 is described as a camera capable of capturing images in a range of about 120 degrees to 150 degrees in a horizontal direction, and in a range of about equal to or greater than 50 degrees to about 70 degrees in a vertical direction, but the embodiments are not limited to this example, and it may be possible to adopt a camera that is able to capture a 360-degree spherical image or a plurality of camera groups that capture images in different directions. The rear camera 22 is arranged on a rear part inside the vehicle or arranged on a rear part outside the vehicle. The rear camera 22 is arranged above, for example, a rear window facing backward. The rear camera 22 continuously captures video images during a time period from start to stop of a power source, such as an engine, of the vehicle, that is, during a time period in which the vehicle is in operation. In the present embodiment, the rear camera 22 continuously captures video images while an accessory power supply of the vehicle is turned on. The rear camera 22 outputs the captured video images to the image capturing control unit 31 included in the record and replay control device 30. The video images captured by the rear camera 22 are a moving image formed of images at, for example, 30 frames per second.

The rear camera 22 serves as both a rear camera that is used for a drive recorder and a camera that is used for a digital inner mirror. The video image captured by the rear camera 22 is recorded as a rear camera video image of the drive recorder, and is displayed on the display unit provided in the digital inner mirror by cutting out the video image used for the digital inner mirror from the video image that has been captured by the rear camera 22. The recording unit 23 is used to temporarily store data of the on-vehicle record and replay device 10. The recording unit 23 is, for example, a semiconductor memory device, such as a random access memory (RAN) or a flash memory, or a recording unit, such as a memory card. Alternatively, the recording unit 23 may be an external recording unit that is wirelessly connected via a communication device (not illustrated). The recording unit 23 records normal recording data or event data on the basis of a control signal that has been output from a recording control unit 34 included in the record and replay control device 30.

The normal recording data includes at least one of a front view video image that has been captured by a front camera 11 and a rear view video image that has been captured by the rear camera 22.

The event data includes at least one of the front view video image and the rear view video image.

The acceleration sensor 24 is a sensor that detects acceleration applied to the vehicle. The acceleration sensor 24 outputs a detection result to an event detection unit 36 included in the record and replay control device 30. The acceleration sensor 24 is a sensor that detects acceleration in, for example, three-axis directions. The three-axis directions are a front-back direction, a left- right direction, and a vertical direction of the vehicle. it is possible to detect a shock applied to the vehicle caused by the acceleration in the three-axis directions.

The operation unit 25 is able to receive various kinds of operation performed on the on-vehicle record and replay device 10. For example, the operation unit 25 is able to receive an operation of manually storing a captured video image in the recording unit 23. The operation unit 25 is a touch panel included in the first display unit 27. For example, the operation unit 25 is able to receive an operation of replaying the event data or the normal recording data recorded in the recording unit 23. For example, the operation unit 25 is able to receive an operation of deleting the event data or the normal recording data that has been recorded in the recording unit 23. For example, the operation unit 25 is able to receive an operation of terminating the normal recording. The operation unit 25 outputs operation information to an operation control unit 37 included in the record and replay control device 30.

The first display unit 27 is a display device for the digital inner mirror, as illustrated in FIG. 2 and FIG. 3. The first display unit 27 is a display including, for example, a liquid crystal display (LCD), an organic electro-luminescence (EL), or the like. As illustrated in FIG. 2 and FIG. 3, the first display unit 27 is formed by being integrated with the front camera 21. The first display unit 27 displays a video image on the basis of a video image signal that is output from a display control unit 42 included in the record and replay control device 30.

In a case where the first display unit 27 functions as a display unit for the digital inner mirror, the first display unit 27 displays the video image that is being captured by the rear camera 22. In this case, on the first display unit 27, a video image in a first range of the video image that has been captured by the rear camera 22 is displayed. Furthermore, in a case where the first display unit 27 functions as a display unit for the drive recorder, the first display unit 27 is able to display the video image that has been recorded in the recording unit 23. In this case, on the first display unit 27, a video image in a second range of the video image that has been captured by the rear camera 22 is displayed. The first range and the second range will be described later.

The GNSS reception unit 26 is configured by a GNSS receiver that receives a GNSS signal sent from GNSS satellites. The GNSS reception unit 26 outputs the received location information signal to a location information acquisition unit 38 included in the record and replay control device 30.

### Record and replay control device

The record and replay control device 30 is an arithmetic processing device (control device) constituted by, for example, a central processing unit (CPU), or the like. The record and replay control device 30 loads a stored program onto a memory and executes a command included in the program. The record and replay control device 30 includes an internal memory (not illustrated), and the internal memory is used to store a program that operates the record and replay control device 30, temporarily store data of the record and replay control device 30, or the like. The record and replay control device 30 includes the image capturing control unit 31, a buffer memory 32, a captured image data processing unit 33, the recording control unit 34, a replay control unit 35, the event detection unit 36, the operation control unit 37, the location information acquisition unit 38, a range identification unit 41, and the display control unit 42.

The image capturing control unit 31 acquires a video image that is obtained by capturing an image of surroundings of the vehicle. More specifically, the image capturing control unit 31 acquires the video images captured by the front camera 21 and the rear camera 22. The image capturing control unit 31 may perform control of capturing images performed by the front camera 21 and the rear camera.

The buffer memory 32 is an internal memory included in the record and replay control device 30, and is a memory for temporarily storing video images that correspond to an amount obtained in a certain time period and that have been acquired by the image capturing control unit 31, while updating the video image.

The captured image data processing unit 33 converts the video image, which is temporarily stored in the buffer memory 32, to an arbitrary file format, such as an MP4 format, which is coded by codec of an arbitrary method, such as H.264 or moving picture experts group (MPEG)-4. The captured image data processing unit 33 generates a captured image file for a fixed time period from the video image that is temporarily stored by the buffer memory 32. As a specific example, the captured image data processing unit 33 generates, as a single file, the video images for 60 seconds in the order in which the video images are recorded from the video image that is temporarily stored by the buffer memory 32. The captured image data processing unit 33 outputs the generated captured image file to the recording control unit 34. Furthermore, the captured image data processing unit 33 outputs the generated captured image file to the display control unit 42. The time period for capturing the video images generated as a captured image file is set to, 60 seconds as one example, but the embodiment is not limited to this example. The video image mentioned here may be data including voice in addition to a video images captured by the front camera 21 and the rear camera 22.

The recording control unit 34 performs control of causing the recording unit 23 to record the captured image file that has been generated as a file by the captured image data processing unit 33. During a time period in which a normal recording process is performed including in a case where the accessory power supply of the vehicle is turned on, the recording control unit 34 records, in the recording unit 23 as the normal recording data that is a rewritable captured image file, the captured image file that has been generated as a file by the captured image data processing unit 33. More specifically, during a time period in which the normal recording process is performed, the recording control unit 34 continuously records the captured image file generated by the captured image data processing unit 33 in the recording unit 23 as the normal recording data, and when the capacity of the recording unit 23 is fully used, the recording unit 23 records a new captured image file by overwriting the oldest captured image file.

Furthermore, in a case where the event detection unit 36 detects an event, the recording control unit 34 stores the video image obtained in a predetermined time period contained in the captured image file generated by the captured image data processing unit 33 in the recording unit 23 as the event data for which overwriting is inhibited.

In a time period in which the normal recording process is being performed, the event data is a captured image file obtained in a predetermined time period before and after a time point at which the event is detected or a captured image file that is generated from the video image, and, an example of the predetermined time period is a time period of about 10 seconds or more and 60 or less before and after the time point at which the event has been detected.

The replay control unit 35 replays the video image recorded by the recording control unit 34. In the present embodiment, the replay control unit 35 replays a captured image file containing the event data, the normal recording data, or the like. The replay control unit 35 controls a replay of the captured image file that contains the event data, the normal recording data, or the like and that has been recorded in the recording unit 23 on the basis of the control signal of the replay operation output from the operation control unit 37.

The event detection unit 36 detects an event occurred with respect to the vehicle. An arbitrary method may be used for a method of detecting the event occurred with respect to the vehicle performed by the event detection unit 36, but as one example, the event detection unit 36 detects an event on the basis of a detection result obtained by the acceleration sensor 24. In this case, when acceleration equal to or greater than a threshold is detected from among the pieces of acceleration detected by the acceleration sensor 24, the event detection unit 36 detects this state as an event. A threshold at which an impact exerted on the vehicle is detected is set to the acceleration that is detected by the event detection unit 36 as an event.

The operation control unit 37 acquires the operation information on an operation received by the operation unit 25. For example, the operation control unit 37 acquires save operation information that indicates a manual save operation to save the event data at the timing of the operation, selection operation information that indicates a selection operation to select the captured image file containing the event data, the normal recording data, or the like, replay operation information that indicates a replay operation to replay the selected captured image file, or deletion operation information that indicates a deletion operation to delete the selected captured image file, and then outputs a control signal. For example, the operation control unit 37 acquires end operation information that indicates that an operation of the normal recording is to be ended, and then outputs the control signal.

The location information acquisition unit 38 calculates, on the basis of the radio wave received by the GNSS reception unit 26, the current location information on the vehicle by using a publicly known method. In a case where the event detection unit 36 detects an event, the location information that has been calculated by the location information acquisition unit 38 is stored together with the event data.

The range identification unit 41 identifies the first range that is a display range that is to be displayed on the first display unit 27 and that is used by the driver of the vehicle to check the rear of the vehicle with respect to the video image acquired by the image capturing control unit 31. In other words, in an imaging angle of view of the captured video image acquired by the image capturing control unit 31, the range identification unit 41 identifies the first range for which the rear of the vehicle is to be checked by the driver of the vehicle by using the first display unit 27 in a case where the first display unit 27 functions as a digital inner mirror. The range identification unit 41 identifies, as the first range, the range that is set in advance and that is in an imaging angle of view of, for example, the video image acquired by the image capturing control unit 31. In the present embodiment, the range identification unit 41 may identify, as the first range, a central portion of the imaging angle of view of, for example, the video image acquired by the image capturing control unit 31.

The process performed by the range identification unit 41 is performed when, for example, the captured image file is recorded in the recording unit 23 by the recording control unit 34, or when the event data or the normal recording data is replayed by the replay control unit 35.

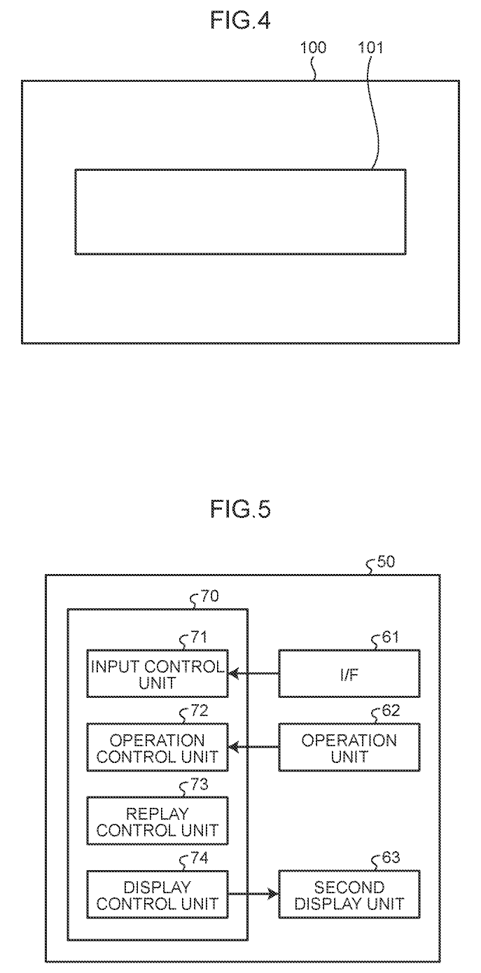

FIG. 4 is a diagram illustrating one example of the second range and the first range. A second range 100 may coincides with an imaging angle of view 100 of the rear camera 22. A first range 101 indicates a range that is displayed in a case where the first display unit 27 functions as a digital inner mirror. The first range 101 is located at, for example, the central portion of the second range 100.

The display control unit 42 controls a display of the video image displayed on the first display unit 27. The display control unit 42 outputs a video image signal on the basis of the video image that is to be output to the first display unit 27. More specifically, the display control unit 42 outputs, to the first display unit 27, a video image signal of a video image that is being captured by the rear camera 22 or a video image signal of a video image that is to be displayed by a replay of the event data or the normal recording data recorded by the recording unit 23.

The display control unit 42 may output, via a communication function of Wi-Fi (registered trademark), a local area network (LANl), or the like to communicate with a replay control device 70, the video image signal of the event data or the normal recording data replayed by the replay control unit 35 to a second display unit 63 that is different from the first display unit 27. In this case, the on-vehicle record and replay device 10 includes a communication unit or an interface unit that is not illustrated (hereinafter, referred to as an "I/F").

When the display control unit 42 causes the second display unit 63 included in the replay device 50 to display the video image that has been replayed by the replay control unit 35, the display control unit 42 causes the second display unit 63 to display the video image in the second range, and display the information that indicates the first range that has been identified by the range identification unit 41. When the display control unit 42 causes the second display unit 63 to display, for example, the event data or the normal recording data, the display control unit 42 causes the second display unit 63 to display a frame line that indicates the first range that is the display range that has been checked by the driver of the vehicle by using the first display unit 27 that is the digital inner mirror.

The information that indicates the first range is the frame line that indicates an outer periphery of, for example, the first range. The information that indicates the first range is not limited to the frame line as long as the first range is able to be distinguished by the information.

In a case where the first display unit 27 functions as a digital inner mirror, the display control unit 42 displays the first range that is to be displayed on the first display unit 27 from the video image that has been captured by the rear camera 22. Specifically, as illustrated in FIG. 4, the display control unit 42 causes the first display unit 27 to display the range that is indicated by the first range 101 from the video image that has been captured by the rear camera 22 and that is indicated by the imaging angle of view 100. In this case, the display control unit 42 may cause the first display unit 27 to display the range by cutting out the first range from the video image captured by the rear camera 22.

In a case where the first display unit 27 is allowed to function as the second display unit, the display control unit 42 causes the first display unit 27 to display the entire of the video image that has been replayed by the replay control unit 35. Specifically, as illustrated in FIG. 10, the display control unit 42 causes the first display unit 27 to display the entire of the video image without changing an aspect ratio of the video image replayed by the replay control unit 35. When the display control unit 42 causes the first display unit 27 to display, for example, the event data or the normal recording data, the display control unit 42 causes the first display unit 27 to display a frame line that indicates the first range 101 that is the display range that has been checked by the driver of the vehicle by using the first display unit 27 that is the digital inner mirror.

### Replay device

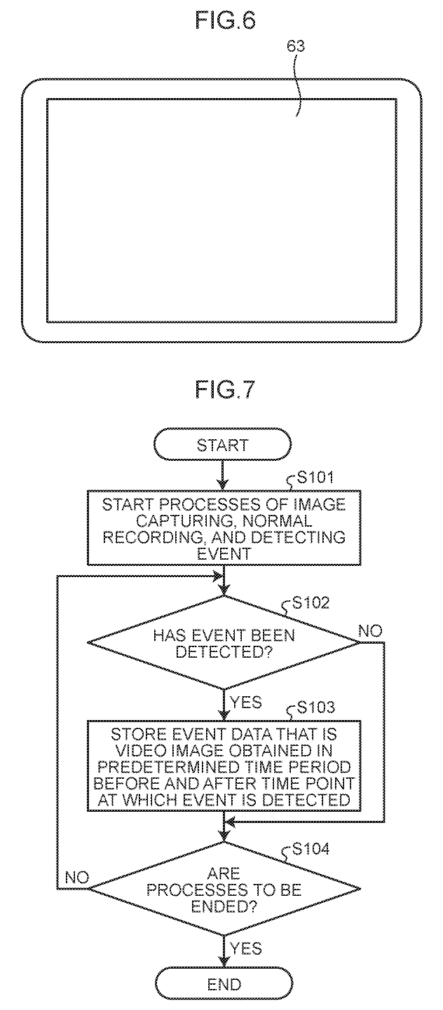

FIG. 5 is a block diagram illustrating an example of a configuration of a replay device that includes a replay control device according to the first embodiment. FIG. 6 is a front view illustrating the second display unit. In the present embodiment, the replay device 50 is a device that is different from the record and replay device 10, such as a navigation system or a personal computer. The replay device 50 is able to display the event data or the normal recording data captured by the record and replay device 10. The replay device 50 includes an I/F 61, an operation unit 62, the second display unit 63, and the replay control device 70.

The I/F 61 is an interface for acquiring a video image signal or a captured image file from an external system. In the present embodiment, the I/F 61 is an interface for acquiring the video image signal or the captured image file from the record and replay device 10. The I/F 61 is, for example, a wired interface that communicates with the record and replay device 10, a wireless interface using a communication function, such as Wi-Fi or a LAN, a reading unit for a recording medium, such as a memory card.

The replay device 50 may acquire the video image replayed by the replay control unit 35 included in the record and replay device 10 via the I/F 61 and may display the acquired video image on the second display unit 63, or may acquire the captured image file containing the event data, the normal recording data, or the like acquired from the record and replay device 10 and may display the acquired captured image file on the second display unit 63 by replaying the acquired captured image file by a replay control unit 73 included in the replay device 50.

The operation unit 62 is able to receive various kinds of operations performed with respect to the replay device 50. The operation unit 62 is a touch panel included in, for example, the second display unit 63. For example, the operation unit 62 is able to receive an operation to replay the event data or the normal recording data that is the captured image file acquired via the I/F 61. The operation unit 62 outputs the operation information to an operation control unit 72 included in the replay control device 70.

The second display unit 63 is a display that includes, for example, a liquid crystal display, an organic EL display, or the like. The second display unit 63 functions as a display unit of the drive recorder, and is able to display the event data or the normal recording data captured by the record and replay device 10. The second display unit 63 displays a video image on the basis of the video image signal output from a display control unit 74 included in the replay control device 70. The second display unit 63 displays the video image that has been acquired via the I/F 61. In a case where the video image that has been captured by the rear camera 22 and that is included in the event data or the normal recording data captured by the record and replay device 10 is displayed on the second display unit 63, a video image that is in the second range and that is included in the video image captured by the rear camera 22 is displayed on the second display unit 63. The video image captured by the rear camera 22 may be displayed on the second display unit 63, or the video image captured by the rear camera 22 and the video image captured by the front camera 21 may be displayed at the same time.

The second display unit 63 may be, for example, the first display unit 27 included in the record and replay device 10. In this case, the record and replay control device 30 illustrated in FIG. 1 constitutes the present disclosure.

### Replay control device

The replay control device 70 is, for example, an arithmetic processing device (control device) constituted by a CPU or the like. The replay control device 70 loads a stored program onto a memory and executes a command included in the program. The replay control device 70 includes an internal memory (not illustrated), and the internal memory is used to store a program that operates the replay control device 70, to temporarily store data of the replay control device 70, or the like. The replay control device 70 includes an input control unit 71, the operation control unit 72, the replay control unit 73, and the display control unit 74.

The input control unit 71 perform control of acquisition of the video image signal and the captured image file from an external device, such as the record and replay device 10, via the I/F 61.

The operation control unit 72 acquires the operation information on the operation received by the operation unit 62. For example, the operation control unit 72 acquires the selection operation information that indicates a selection operation to select the event data or the replay operation information that indicates a replay operation to replay the event data or the normal recording data, and then outputs a control signal.

The replay control unit 73 replays the selected event data or the normal recording data. The replay control unit 73 performs control of a replay of the event data or the normal recording data that has been acquired via the I/F 61 on the basis of the control signal of the selection operation and the replay operation output from the operation control unit 72.

The display control unit 74 controls a display of the video image displayed on the second display unit 63. The display control unit 74 outputs the video image signal that causes the video image to be output to the second display unit 63. When the display control unit 74 causes the second display unit 63 to display the video image, the display control unit 74 displays the information that indicates the first range identified by the range identification unit 41 included in the record and replay control device 30.

In the present embodiment, the display control unit 74 causes the second display unit 63 to display the replayed event data or the replayed normal recording data. In the present embodiment, when the display control unit 74 causes the second display unit 63 to display the event data or the normal recording data, the display control unit 74 causes the second display unit 63 to display the event data or the normal recording data in the second range, and to display the information that indicates the first range identified by the range identification unit 41 included in the record and replay control device 30. In the present embodiment, when the display control unit 74 causes the second display unit 63 to display the event data or the normal recording data, as illustrated in FIG. 4, the display control unit 74 causes the second display unit 63 to display the frame line that indicates the first range 101 that is the display range that has been checked by the driver of the vehicle by using the first display unit 27 that is the digital inner mirror, with respect to the video image that has been captured by the rear camera 22, that is indicated by the second range 100, and that is included in the event data or the normal recording data to be displayed.

In a case where the replay device 50 only functions as a simple display device that displays the video image on the basis of the video image signal output from the record and replay device 10, the operation unit 62, and the operation control unit 72 and the replay control unit 73 that are included in the replay control device 70 are not essential components. In this case, the video image replayed by the replay control unit 35 included in the record and replay device 10 is acquired from the record and replay device 10 by the input control unit 71 via the I/F 61. Then, the display control unit 74 simply displays the video image on the second display unit 63.

### Recording process

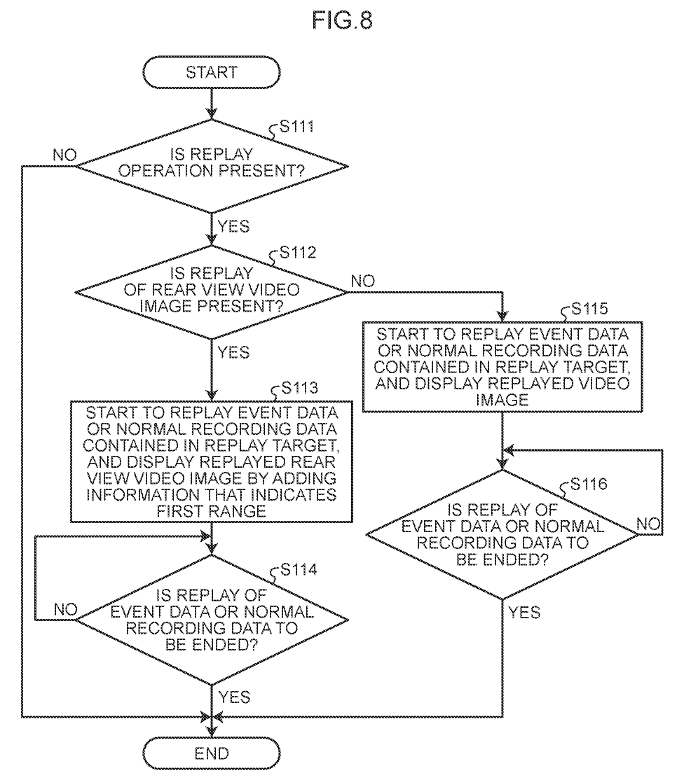

In the following, the flow of a recording process performed in the record and replay control device 30 will be described with reference to FIG. 7 and FIG. 8. FIG. 7 is a flowchart illustrating the recording process performed in the record and replay control device according to the first embodiment. Here, a case in which a normal recording process and the recording process of recording the event data are performed will be described.

The process illustrated in FIG. 7 is started in accordance with the start of the operation of a vehicle on which, for example, the on-vehicle record and replay device 10 is mounted, and is ended in accordance with the end of the operation of the vehicle. The record and replay control device 30 starts processes of image capturing, normal recording, and detecting an event (Step S101). More specifically, the record and replay control device 30 causes the image capturing control unit 31 to start to perform the image capturing process using the front camera 21 and the rear camera. The record and replay control device 30 causes the captured image data processing unit 33 to generate a captured image file for each video image in a predetermined time period from the video image that has been recorded in the buffer memory 32. The record and replay control device 30 causes the recording unit 23 to record the captured image file by using the recording control unit 34. The record and replay control device 30 causes the event detection unit 36 to start to detect an event on the basis of the detection result obtained by the acceleration sensor 24. The record and replay control device 30 proceeds to Step S102.

The record and replay control device 30 causes the event detection unit 36 to determine whether or not an event has been detected (Step S102). More specifically, in a case where it is determined by the event detection unit 36 that an event has been detected (Yes at Step S102), the record and replay control device 30 proceeds to Step S103. In a case where it is not determined by the event detection unit 36 that an event has been detected (No at Step S102), the record and replay control device 30 proceeds to Step S104.

In a case where it is determined that an event has been detected (Yes at Step S102), the record and replay control device 30 stores the event data that is the video image obtained in a predetermined time period before and after a time point at which the event is detected (Step S103). More specifically, the record and replay control device 30 causes the recording control unit 34 to store, in the recording unit 23, the captured image file as the event data including at least the occurrence time point of the event from the captured image file that has been recorded in the recording unit 23 by the captured image data processing unit 33. The record and replay control device 30 proceeds to Step S104.

The record and replay control device 30 determines whether or not the processes of image capturing, normal recording, and detecting an event are to be ended (Step S104). More specifically, the record and replay control device 30 determines to end the processes of image capturing, normal recording, and detecting an event under an arbitrary condition such as a case in which end operation information is output, an operation of the vehicle is ended, or the like by the operation control unit 37 (Yes at Step S104), and ends the processes. In a case where the end operation information is not output by the operation control unit 37, the record and replay control device 30 determines that the processes of image capturing, normal recording, and detecting an event are not to be ended (No at Step S104), and then performs the process at Step S102 again.

### Replay process

In the following, the flow of the replay process performed in the record and replay control device 30 will be described with reference to FIG. 8. FIG. 8 is a flowchart illustrating the flow of the replay process performed in the record and replay control device according to the first embodiment.

The record and replay control device 30 determines whether or not a replay operation is present (Step S111). An item to be subjected to the replay operation is the captured image file that contains the event data, the normal recording data, or the like and that has been recorded in the recording unit 23. Furthermore, the replay operation mentioned here includes an instruction to select the captured image file that contain the event data, the normal recording data, or the like and that is to be replayed and an instruction to start a replay of the selected captured image file. In a case where the record and replay control device 30 acquires the operation information that indicates the replay operation by using the operation control unit 37, the record and replay control device 30 determines that the replay operation is present. In a case where the record and replay control device 30 determines that the replay operation is present by using the operation control unit 37 (Yes at Step S111), the record and replay control device 30 proceeds to Step S112. In a case where the record and replay control device 30 does not determine that replay operation is present by using the operation control unit 37 (No at Step S111), the record and replay control device 30 ends the process.

In a case where it is determined that the replay operation is present (Yes at Step S111), the record and replay control device 30 determines whether or not a replay of the rear view video image is present (Step S112). More specifically, in a case where a rear view video image is included in the event data or the normal recording data that is to be replayed and that is subjected to the replay operation by the operation control unit 37, the record and replay control device 30 determines that a replay of the rear view video image is present. A case in which the rear view video image is present indicates a case in which, for example, the event data or the normal recording data that has been subjected to the replay operation is the event data or the normal recording data, respectively, based on the video image captured by the rear camera 22, or is the event data or the normal recording data, respectively, based on the video image captured by the front camera 21 and the video image captured by the rear camera 22. In other words, the process at Step S112 may determine whether or not the replay operation on the video image that includes the rear view video image or the rear view video image has been performed. Furthermore, instead of determining whether or not a replay of the rear view video image is present, or, in addition to determining whether or not a replay of the rear view video image is present, the process at Step S112 may determine whether or not information that indicates the first range is included in the event data or the normal recording data to be replayed.

In a case where the record and replay control device 30 determines that a replay of the rear view video image is present (Yes at Step S112), the record and replay control device 30 proceeds to Step S113. In a case where the record and replay control device 30 does not determine that the rear view video image is present (No at Step S112), the record and replay control device 30 proceeds to Step S115.

In a case where it is determined that a replay of the rear view video image is present (Yes at Step S112), the record and replay control device 30 starts to replay the event data or the normal recording data contained in the replay target, and then displays the replayed rear view video image by adding the information that indicates the first range (Step S113). More specifically, the record and replay control device 30 causes the replay control unit 35 to start to replay the event data or the normal recording data contained in the replay target, generates a video image signal that includes the information indicating the first range with respect to the replayed rear view video image containing the event data or the normal recording data, and displays the video image on the first display unit 27 by causing the display control unit 42 to output the video image signal to the first display unit 27. After the process at Step S113, the record and replay control device 30 proceeds to Step S114.

The record and replay control device 30 determines whether or not the replay of the event data or the normal recording data is to be ended (Step S114). In a case where the record and replay control device 30 replays the event data or the normal recording data to the end, or in a case where an operation to stop the replay has been performed, the record and replay control device 30 determines to end the replay of the event data or the normal recording data. In a case where the record and replay control device 30 determines to end the replay (Yes at Step S114), the record and replay control device 30 ends the process. In a case where the record and replay control device 30 does not determine to end the process (No at Step S114), the record and replay control device 30 again performs the process at Step S114.

In a case where it is not determined that the replay of the rear view video image is present (No at Step S112), the record and replay control device 30 starts to replay the event data or the normal recording data contained in the replay target, and displays the replayed video image (Step S115). More specifically, the record and replay control device 30 starts to replay the event data or the normal recording data contained in the replay target by using the replay control unit 35, and causes the display control unit 42 to display the video image on the first display unit 27 by outputting the video image signal to the first display unit 27. After the process at Step S115, the record and replay control device 30 proceeds to Step S116.

The record and replay control device 30 determines whether or not to end the replay of the event data or the normal recording data (Step S116). In a case where the record and replay control device 30 replays the event data or the normal recording data to the end, or in a case where an operation to stop the replay has been performed, the record and replay control device 30 determines to end the replay of the event data or the normal recording data. In a case where the record and replay control device 30 determines to end the replay (Yes at Step S116), the record and replay control device 30 ends the process. In a case where the record and replay control device 30 does not determine to end the process (No at Step S116), the record and replay control device 30 again performs the process at Step S116.

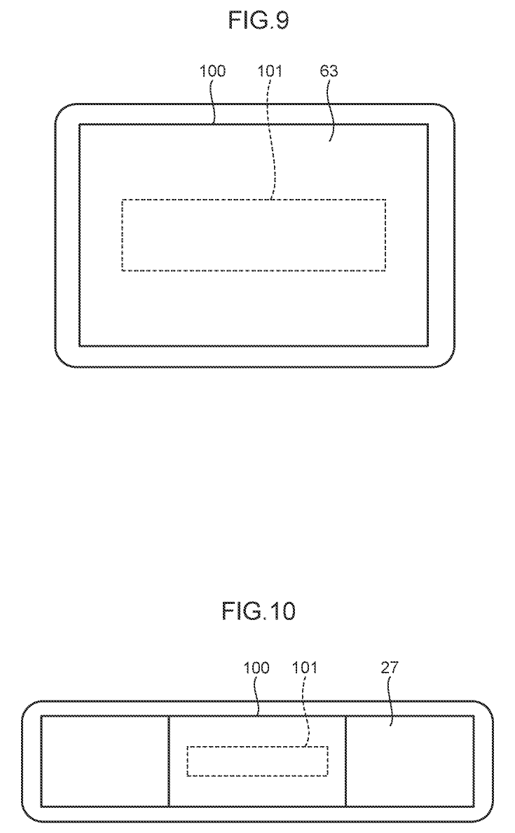

In the following, a case in which the record and replay control device 30 causes the second display unit 63 included in the replay device 50 to display the event data or the normal recording data via a communication function of Wi-Fi, or the like will be described. At Step S113, the record and replay control device 30 generates a video image signal that includes the information indicating the first range with respect to the replayed rear view video image containing the event data or the normal recording data, and transmits the generated video image signal to the replay device 50, whereby a video image 100 of the event data or the normal recording data in which information that indicates the first range 101 is drawn is displayed on the second display unit 63 included in the replay device 50, as illustrated in FIG. 9. FIG. 9 is a diagram illustrating one example in which a video image in which the first range is drawn in the second display unit. By performing the process at Step S115, the event data or the normal recording data is displayed on the second display unit 63 included in the replay device 50.

A case in which the record and replay control device 30 causes the first display unit 27 to display the event data or the normal recording data will be described. By performing the process at Step S113, as illustrated in FIG. 10, the video image 100 that contains the event data or the normal recording data and in which the information indicating the first range 101 is drawn is displayed on the first display unit 27. FIG. 10 is a diagram illustrating another example of a video image in which the first range is drawn in the first display unit. By performing the process at Step S115, the event data or the normal recording data is displayed on the first display unit 27.

### Effects

As described above, in the present embodiment, when the replayed video image is displayed on the first display unit 27 or the second display unit 63 in the second range, the information that indicates the first range that is to be displayed on the first display unit 27 and that is used by the driver of the vehicle to check the rear of the vehicle is displayed. In the present embodiment, when the replayed event data is displayed on the first display unit 27 or the second display unit 63 in the second range, the information that indicates the first range is displayed. According to the present embodiment, even in a case of the normal recording data or in a case of the event data, it is possible to clarify the range that has been displayed as the digital inner mirror at the time of the replay. According to the present embodiment, in a time period over which the video image is replayed, the driver of the vehicle is able to identify the range in which the rear is able to be checked by using the digital inner mirror. With the present embodiment, in a case where an accident or the like has occurred, it is possible for the driver of the vehicle to easily and objectively indicate the extent to which the cause of the incident can be checked. In this way, with the present embodiment, it is possible to more appropriately understand the cause of an accident or the like at the time of replay of the event data, or the like.

According to the present embodiment, in a case where a display size of a different vehicle or the like that is being checked by the driver of the vehicle by using the digital inner mirror is different from a display size of the different vehicle that is being displayed on the replayed rear view video image, the driver of the vehicle is able to easily recognize a distance or the like with the different vehicle as a result of the first range being displayed.

### Second Embodiment

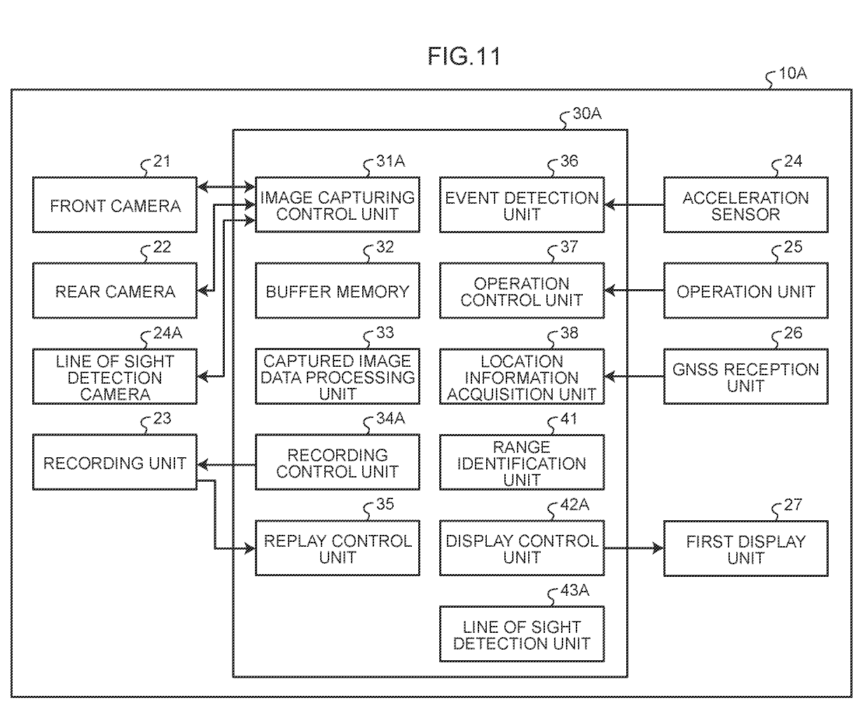

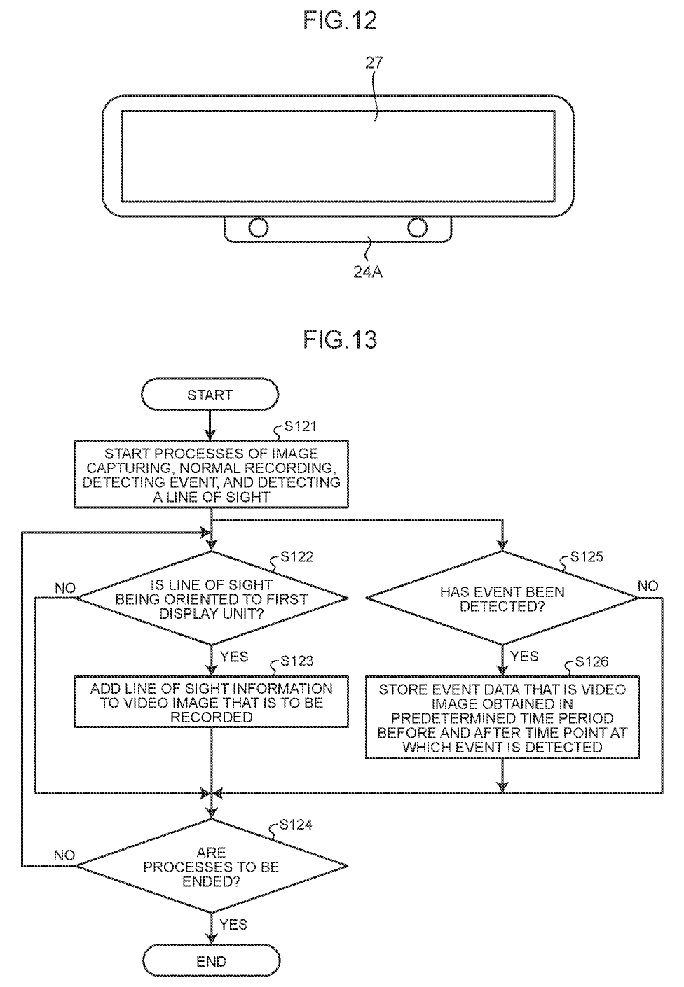

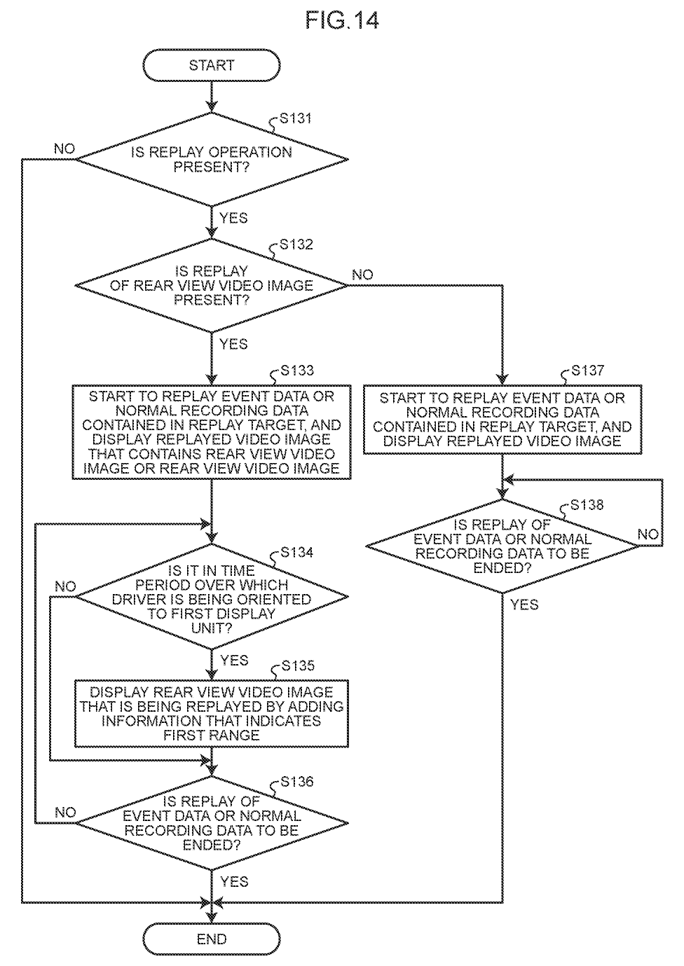

An on-vehicle record and replay device 10A according to the present embodiment will be described with reference to FIG. 11 to FIG. 14. FIG. 11 is a block diagram illustrating an example of a configuration of the on- vehicle record and replay device that includes a record and replay control device according to the second embodiment. FIG. 12 is a front view illustrating the first display unit and a line of sight detection camera. FIG. 13 is a flowchart illustrating the flow of a recording process performed in the record and replay control device according to the second embodiment. FIG. 14 is a flowchart illustrating the flow of a replay process performed in the record and replay control device according to the second embodiment. The basic configuration of the on-vehicle record and replay device 10A is the same as that of the on- vehicle record and replay device 10 according to the first embodiment. In a description below, components having the same function as those of the on-vehicle record and replay device 10 are assigned the same or the corresponding reference numerals and descriptions thereof in detail will be omitted. The on-vehicle record and replay device 10A is different from the first embodiment in that a line of sight detection camera 24A and a line of sight detection unit 43A are included, and the processes performed in an image capturing control unit 31A, a recording control unit 34A, and a display control unit 42A are different.

The line of sight detection camera 24A is a camera that captures an image such that a line of sight of a driver is able to be detected. The line of sight detection camera 24A is a camera installed in the vicinity of a display screen of the first display unit 27, as illustrated in FIG. 12. The line of sight detection camera 24A may be arranged on a dashboard. The line of sight detection camera 24A captures an image in a direction opposite to the display screen of the first display unit 27. In the present embodiment, the line of sight detection camera 24A is, for example, a camera that captures a face portion of the driver of the vehicle. The line of sight detection camera 24A may be a plurality of camera group. The line of sight detection camera 24A is constituted by, for example, a visible light camera or a near infrared camera. The line of sight detection camera 24A may be constituted by, for example, a combination of a visible light camera and a near infrared camera. In the present embodiment, the line of sight detection camera 24A continuously captures video images during a time period in which the accessory power supply of the vehicle is turned on. The line of sight detection camera 24A outputs the captured video image to the image capturing control unit 31A included in a record and replay control device 30A.

The line of sight detection unit 43A detects a line of sight direction of the driver of the vehicle from the video image that has been captured by the line of sight detection camera 24A that captures an image in a direction opposite to the display screen of the first display unit 27. The line of sight detection unit 43A recognizes the face of the driver of the vehicle included in the captured video image from the video image that has been captured by the line of sight detection camera 24A and that has been acquired by a captured image data acquisition unit 111, and then detects the line of sight direction from the video image of the detected eyes. The line of sight detection unit 43A detects that the driver of the vehicle is looking at the first display unit 27 on the basis of corneal reflection and positions of pupils, from the video image obtained by capturing the face (both eyes) of the driver of the vehicle. In a case where, for example, it has been detected that the line of sight of the driver of the vehicle is oriented to the first display unit 27, and the line of sight of the driver of the vehicle is continuously oriented to the first display unit 27 for, for example, 0.5 or longer, the line of sight detection unit 43A may determine that the driver of the vehicle has looked at the first display unit 27.

The recording control unit 34A records the information indicating that the line of sight of the driver is being oriented to the first display unit 27 in an associated manner with the video image.

When the display control unit 42A causes the first display unit 27 to display the video image that has been replayed by the replay control unit 35, the display control unit 42A causes the first display unit 27 to display the information that indicates the first range identified by the range identification unit 41 in a time period over which the line of sight detection unit 43A detects that the line of sight of the driver of the vehicle is being oriented to the first display unit 27.

Furthermore, in a similar manner as in the replay device 50, when the display control unit 42A causes the second display unit 63 to display the video image that has been replayed by the replay control unit 73, the display control unit 42A causes the second display unit 63 to display the information that indicates the first range identified by the range identification unit 41 in a time period over which the line of sight detection unit 43A detects that the line of sight of the driver of the vehicle is being oriented to the first display unit 27.

### Recording process

In the following, the flow of the recording process will be described with reference to FIG. 13. The processes to be performed at Step 5124, Step 5125, and Step 5126 illustrated in FIG. 13 are the same as the processes performed at Step S104, Step S102, and Step S103 described above in the flowchart illustrated in FIG. 7.

The record and replay control device 30A starts processes of image capturing, normal recording, detecting an event, and detecting a line of sight (Step S121). More specifically, the record and replay control device 30A causes the image capturing control unit 31 to start to perform the image capturing process using the front camera 21, the rear camera 22, and the line of sight detection camera 24A. The record and replay control device 30A causes the captured image data processing unit 33 to generate a captured image file for each video image in a predetermined time period from the video image that has been recorded in the buffer memory 32. The record and replay control device 30A causes the recording control unit 34A to record the captured image file in the recording unit 23. The record and replay control device 30A causes the event detection unit 36 to detect an event on the basis of the detection result obtained by the acceleration sensor 24. The record and replay control device 30A causes the line of sight detection unit 43A to detect the line of sight direction of the driver from the video image that has been captured by the line of sight detection camera 24A. The record and replay control device 30A proceeds to Step 5122.

The record and replay control device 30A causes the line of sight detection unit 43A to determine whether or not the line of sight of the driver is being oriented to the first display unit 27 (Step S122). In a case where the record and replay control device 30A causes the line of sight detection unit 43A to determine whether or not the line of sight of the driver is being oriented to the first display unit 27 (Yes at Step S122), the record and replay control device 30A proceeds to Step S123. In a case where the record and replay control device 30A causes the line of sight detection unit 43A not to determine that the line of sight of the driver is being oriented to the first display unit 27 (No at Step S122), the record and replay control device 30A proceeds to Step S124.

In a case where it is determined that the line of sight of the driver is being oriented to the first display unit 27 (Yes at Step S122), the record and replay control device 30A adds the line of sight information to the video image that is to be recorded (Step S123). More specifically, the record and replay control device 30A causes the captured image data processing unit 33 to add the line of sight information that includes the time period over which it is determined that the line of sight is being oriented to the first display unit 27 to the captured image file that is recorded in the recording unit 23. The record and replay control device 30A causes the recording control unit 34A to store the recorded data in which the line of sight information is added in the recording unit 23. The record and replay control device 30A proceeds to Step S124.

### Replay process

In the following, the flow of the replay process will be described with reference to FIG. 14. The processes to be performed at Step S131 and Step 5132 and the processes to be performed at Step S136 to Step S138 illustrated in FIG. 14 are the same as the processes performed at Step 5111 and Step S112 and the processes performed at Step S114 to Step S116 described above in the flowchart illustrated in FIG. 8.

In a case where it is determined that a reply of the rear view video image is present (Yes at Step S132), the record and replay control device 30A starts to replay the event data or the normal recording data contained in the replay target, and then displays the replayed video image that contains the rear view video image or the rear view video image (Step S133). More specifically, the record and replay control device 30A causes the replay control unit 35 to start the replay of the event data or the normal recording data contained in the replay target, and causes the first display unit 27 to display the video image by outputting the video image signal for displaying the replayed rear view video image containing event data or the normal recording data or the video image that includes the rear view video image. After the process at Step S133, the record and replay control device 30A proceeds to Step S134.

The record and replay control device 30A determines whether or not it is in a time period over which the driver is being oriented to the first display unit 27 (Step S134). More specifically, in a case where the information indicating that the driver is being oriented to the first display unit 27 is added to the event data or the normal recording data that is being replayed, the record and replay control device 30A determines that it is in a time period over which the driver is being oriented to the first display unit 27. In a case where the record and replay control device 30A determines that it is in a time period over which the driver is being oriented to the first display unit 27 (Yes at Step S134), the record and replay control device 30A proceeds to Step S135. In a case where the record and replay control device 30A does not determine that it is in a time period over which the driver is being oriented to the first display unit 27 (No at Step S134), the record and replay control device 30A proceeds to Step S136.

In a case where the record and replay control device 30A determines that it is in a time period over which the driver is being oriented to the first display unit 27 (Yes at Step S134), the record and replay control device 30A displays the rear view video image that is being replayed by adding the information that indicates the first range (Step S135). More specifically, the record and replay control device 30A generates a video image signal that includes the information indicating the first range with respect to the rear view video image that is being replayed by the replay control unit 35 and that contains the event data or the normal recording data, and causes the first display unit 27 to display the video image by causing the display control unit 42A to output the video image signal to the first display unit 27. The record and replay control device 30A proceeds to Step S136.

### Effects

As described above, in the present embodiment, when the replayed video image is displayed on the second display unit 63, the information that indicates the first range is displayed in the time period over which it is detected that the line of sight of the driver of the vehicle is being oriented to the first display unit 27. According to the present embodiment, even in a case of the video image with normal recording or in a case of the event data, it is possible to clarify the range that has been displayed as the digital inner mirror at the time of the replay and it is also possible to clarify whether or not the driver of the vehicle has looked at the digital inner mirror. According to the present embodiment, in a time period over which the video image is replayed, it is possible to identify the range that has been checked by the driver of the vehicle by using the digital inner mirror. With the present embodiment, in a case where an accident or the like has occurred, it is possible to ascertain the extent to which the driver of the vehicle has checked the incident or the like that caused.

### Third Embodiment

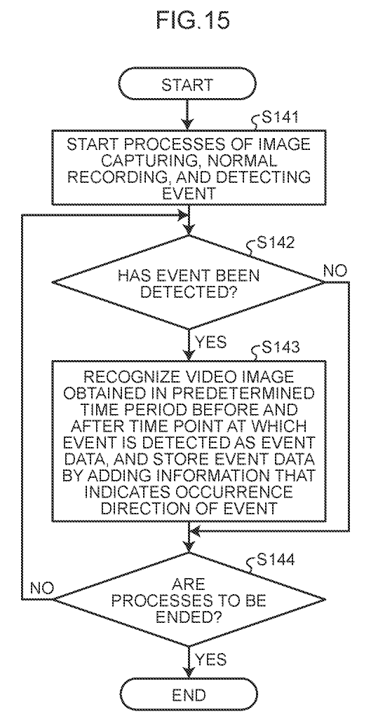

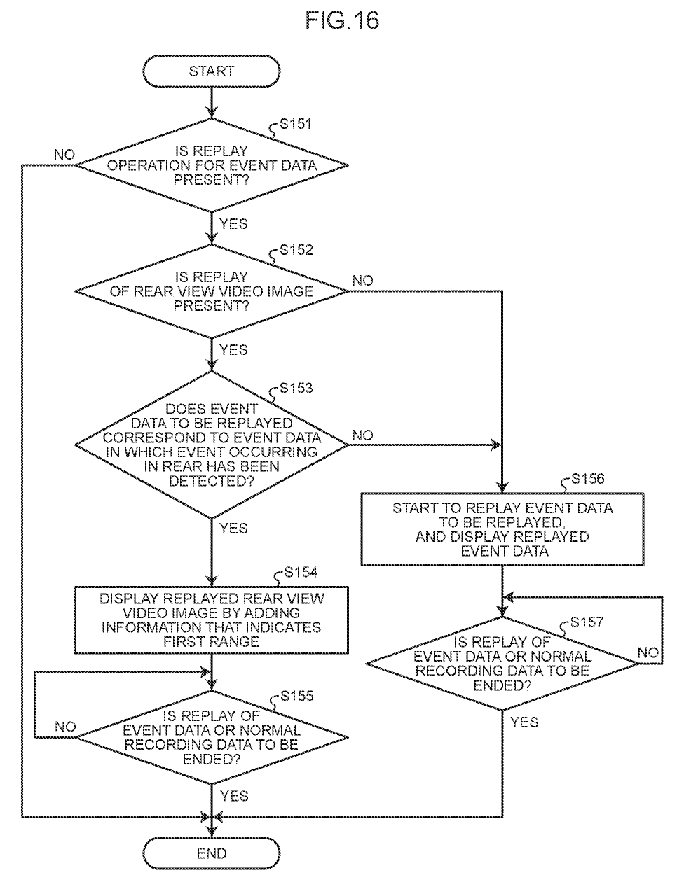

The on-vehicle record and replay device 10 according to the present embodiment will be described with reference to FIG. 15 and FIG. 16. FIG. 15 is a flowchart illustrating the flow of a recording process performed in a record and replay control device according to a third embodiment. FIG. 16 is a flowchart illustrating the flow of a replay process performed in the record and replay control device according to the third embodiment. The on- vehicle record and replay device 10 according to the present embodiment is different from the first embodiment in that the processes performed in the event detection unit 36, the recording control unit 34, and the display control unit 42 are different.

The event detection unit 36 further detects an occurrence direction of the event occurred with respect to the vehicle, in addition to the event occurred with respect to the vehicle. More specifically, the event detection unit 36 detects the occurrence direction of the event from the direction of the acceleration applied to the vehicle.

For example, in a case where an increase in acceleration to the right direction of the vehicle is detected around the time point at which the event is detected, it is found that an impact is applied to the vehicle from the left direction to the right direction. In this case, the occurrence direction of the event is the left direction.

The recording control unit 34 includes the information that indicates the occurrence direction of the event in the event data, and stores the event data in the recording unit 23. More specifically, the recording control unit 34 associates the event data with the information that indicates the detection direction of the event, and stores the associated event data in the recording unit 23.

When the display control unit 42 causes the second display unit 63 to display the event data based on the event that has occurred in the rear of the vehicle, the display control unit 42 causes the second display unit 63 to display the information that indicates the first range identified by the range identification unit 41.

### Recording process

In the following, the flow of the recording process will be described with reference to FIG. 15. The processes to be performed at Step S141, Step S142, and Step S144 illustrated in FIG. 15 are the same as the processes performed at Step S101, Step S102, and Step S104 described above in the flowchart illustrated in FIG. 7.

In a case where it is determined that an event has been detected (Yes at Step S142), the record and replay control device 30 recognizes the video image obtained in a predetermined time period before and after a time point at which the event is detected as the event data, and stores the event data by adding the information that indicates the occurrence direction of the event (Step S143). More specifically, the record and replay control device 30 uses the captured image file that includes at least the time point at which the event has occurred and that has been selected from the captured image file recorded in the recording unit 23 by the captured image data processing unit 33 as the event data, and causes the recording control unit 34 to store the information that indicates the occurrence direction of the event together with the event data in the recording unit 23. The record and replay control device 30 proceeds to Step S144.

### Replay process

In the following, the flow of the replay process will be described with reference to FIG. 16. The processes to be performed at Step S152, Step S154, Step 5155, and Step S157 illustrated in FIG. 16 are the same as the processes performed at Step S112, Step S113, Step S114, and Step S116 described above in the flowchart illustrated in FIG. 8.

The record and replay control device 30 determines whether or not a replay operation for the event data is present (Step S151). The replay operation performed in this case includes an instruction to select the captured image file that contains the event data or the like and that is to be replayed and an instruction to start a replay of the selected captured image file. In a case where the record and replay control device 30 causes the operation control unit 37 to acquire the operation information that indicates the replay operation for the event data, the record and replay control device 30 determines that the replay operation for the event data is present. In a case where the record and replay control device 30 causes the operation control unit 37 to determine that the replay operation for the event data is present (Yes at Step S151), the record and replay control device 30 proceeds to Step S152. In a case where the record and replay control device 30 causes the operation control unit 37 not to determine that the replay operation for the event data is present (No at Step S151), the record and replay control device 30 ends the process.

In a case where the record and replay control device 30 determines that a replay of the rear view video image is present (Yes at Step S152), the record and replay control device 30 determines whether or not the event data to be replayed is the event data in which an event occurring in the rear has been detected (Step S153). More specifically, in a case where the occurrence direction of the event associated with the event data to be replayed is the rear, the record and replay control device 30 determines that the event data to be replayed is the event data in which the event occurring in the rear has been detected. In a case where the record and replay control device 30 determines that the event data to be replayed is the event data in which the event occurring in the rear has been detected (Yes at Step S153), the record and replay control device 30 proceeds to Step S154. In a case where the record and replay control device 30 does not determine that the event data to be replayed is the event data in which the event occurring in the rear has been detected (No at Step S153), the record and replay control device 30 proceeds to Step S156. Furthermore, at Step S156, the record and replay control device 30 starts to replay the event data to be replayed, and then displays the replayed video image.

### Effects

As described above, in the present embodiment, when the event data based on the event that has occurred in the rear of the vehicle is displayed on the second display unit 63, the information that indicates the first range is displayed. According to the present embodiment, it is possible to clarify the range that has been displayed as the digital inner mirror at the time of the replay of the event data on the event that has occurred in the rear of the vehicle. According to the present embodiment, in a time period over which the video image is replayed, the driver of the vehicle is able to identify the range in which the rear is able to be checked by using the digital inner mirror. According to the present embodiment, it is possible to ascertain the extent to which the driver of the vehicle has checked the incident or the like that caused with respect to the event, such as an accident.

In the above, the on-vehicle record and replay device and the replay device according to the present disclosure have been described, but the present disclosure may also be implemented with various kinds of embodiments other than the embodiments described above.

Each of the components included in the on-vehicle record and replay device and the replay device illustrated in the drawings are only for conceptually illustrating the functions thereof and are not always physically configured as illustrated in the drawings. In other words, the specific shape of a separate or integrated device is not limited to the drawings. Specifically, all or part of the device can be configured by functionally or physically separating or integrating any of the units depending on various loads or use conditions.

The configuration of each of the on-vehicle record and replay device and the replay device is implemented as, for example, software, by programs, or the like loaded in a memory. In the embodiments described above, the description has been given as the functional blocks that are implemented in cooperation with these pieces of hardware or software. In other words, the functional blocks can be implemented in various forms by using only hardware, using only software, or using a combination of hardware and software.

The components described above include one that can easily be thought of by a person skilled in the art and one that is practically identical. Further, the configurations described above may be combined appropriately. Furthermore, various omissions, replacements, and modifications of the components may be made within the scope of the present invention.

### Other embodiments

The replay process described above may be performed by the replay control device 70 included in the replay device 50. In this case, the processes performed by the operation control unit 37 are performed by the operation control unit 72, and the processes performed by the display control unit 42 are performed by the display control unit 74. In this case, the event data or the normal recording data captured by the record and replay device 10 is stored in the memory card after the first range has been added to the data. As a result of this, it is assumed that the information that indicates the first range has been added to the rear view video image at the time at which the replay device 50 acquires the video image via the I/F 61.

In the above, a case has been described as an example in which a record and replay control method is performed by the record and replay device, but the record and replay control method may be performed by the record and replay system. In the above, a case has been described as an example in which the normal recording process is performed, but the same applies to a case in which a process of image capturing is started after an event has been detected. In this case, the video image resulting from the event is a video image obtained in a predetermined time period elapsed after the event has been detected and the process of image capturing is then started, and an example of the predetermined time period is a time period between, for example, about 10 seconds or longer and 60 seconds or shorter.

In a case where the video image recorded by the recording control unit 34 included in the record and replay control device 30 illustrated in FIG. 1 is replayed by the replay control device 70 illustrated in FIG. 5 and is displayed on the second display unit 63, the configuration of the present disclosure may be a configuration in which the video image recorded by the recording control unit 34 may be replayed by the replay control unit 73 and displayed on the second display unit 63. In this case, the configuration of the present disclosure implemented by the replay control device 70 is able to be represented by supplementary notes 1 to 5 described below.

### Supplementary Note 1

A replay control device comprising: a video image acquisition unit that acquires a video image that has been captured by a rear camera that captures an image of a rear of a vehicle, and information that indicates a range that is to be displayed on a first display unit and that is used by a driver of the vehicle to check the rear of the vehicle in the video image; a replay control unit that replays the video image acquired by the video image acquisition unit; and a display control unit that displays, when the video image replayed by the replay control unit is displayed on a second display unit, the information that has been acquired by the video image acquisition unit and that indicates the range that is to be displayed on the first display unit.

### Supplementary Note 2

The replay control device according to Supplementary Note 1, wherein

the video image acquisition unit further acquires information that indicates that a line of sight of the driver of the vehicle is being oriented to the first display unit, and when the display control unit displays the video image replayed by the replay control unit on the second display unit, the display control unit displays the information that indicates the range that is to be displayed on the first display unit, based on the information acquired by the video image acquisition unit, in a time period over which it is detected that the line of sight of the driver of the vehicle is being oriented to the first display unit.

### Supplementary Note 3

The replay control device according to Supplementary Note 1 or 2, wherein, when the replay control unit displays the event data acquired by the video image acquisition unit on the second display unit, the display control unit displays the information that indicates the range that is to be displayed on the first display unit and that has been acquired by the video image acquisition unit.

### Supplementary Note 4

The replay control device according to Supplementary Note 3, wherein the video image acquisition unit further acquires, in addition to the event data, information that indicates an occurrence direction of the event contained in the event data, and when the display control unit displays the event data based on the event that has occurred in the rear of the vehicle on the second display unit, the display control unit displays the information that has been acquired by the video image acquisition unit and that indicates the range that is to be displayed on the first display unit.

### Supplementary Note 5

A replay control method executed by a replay control device, the replay control method comprising: a video image acquisition step of acquiring a video image that has been captured by a rear camera that captures an image of a rear of a vehicle, and information that indicates a range that is to be displayed on a first display unit and that is used by a driver of the vehicle to check the rear of the vehicle in the video image; a replay control step of replaying the video image acquired at the video image acquisition step; and a display control step of displaying, when the video image replayed at the replay control step is displayed on a second display unit, the information that has been acquired at the video image acquisition step and that indicates the range that is to be displayed on the first display unit. In Supplementary Notes 1 to 5 described above, the video image acquisition unit indicates the input control unit 71.

According to the present disclosure, an advantage is provided in that it is possible to more easily understand a cause or the like of an accident or the like by clarifying a range that is being visually checked by the driver of the vehicle by using the digital inner mirror when a video image, such as event data, of a drive recorder is being replayed.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A record and replay control device comprising:
an image capturing control unit that acquires a video image that has been captured by a rear camera that captures an image of a rear of a vehicle;
a range identification unit that identifies a first range that is to be displayed on a first display unit and that is used by a driver of the vehicle to check the rear of the vehicle with respect to the video image acquired by the image capturing control unit;
a recording control unit that records the video image acquired by the image capturing control unit in a recording unit;
a replay control unit that replays the video image recorded by the recording control unit; and
a display control unit that displays, when the video image replayed by the replay control unit is displayed on the first display unit or a second display unit that is different from the first display unit in a second range that is larger than the first range, information that indicates the first range on the video image that is displayed in the second range.

2. The record and replay control device according to claim 1, wherein the first display unit has a larger aspect ratio than the second display unit.

3. The record and replay control device according to claim 1 the first range has a larger aspect ratio than the second range.

4. The record and replay control device according to claim 1, further comprising a line of sight detection unit that detects a line of sight of the driver of the vehicle, wherein
the recording control unit records, in an associated manner with the video image, information indicating that the line of sight of the driver of the vehicle is being oriented to the first display unit, and
when the display control unit displays the video image replayed by the replay control unit on the first display unit or the second display unit in the second range, the display control unit displays the information that indicates the first range on the video image that is displayed in the second range in a time period over which the line of sight detection unit detects that the line of sight of the driver of the vehicle is being oriented to the first display unit.

5. The record and replay control device according to claim 1, further comprising an event detection unit that detects an event that has occurred with respect to the vehicle, wherein
the recording control unit records the video image obtained in a predetermined time period based on a time point at which the event detection unit has detected the event in the recording unit as event data,
the replay control unit replays the event data recorded by the recording control unit, and
when the display control unit displays the event data replayed by the replay control unit on the first display unit or the second display unit in the second range, the display control unit displays the information that indicates the first range.

6. The record and replay control device according to claim 5, wherein
the event detection unit further detects, in addition to the detection of the event that has occurred with respect to the vehicle, an occurrence direction of the event in the vehicle,
the recording control unit records the event data by including information that indicates the occurrence direction of the event in the recording unit, and
When the display control unit displays the event data based on the event that has occurred in the rear of the vehicle on the first display unit or the second display unit in the second range, the display control unit displays the information that indicates the first range.

7. The record and replay control device according to claim 1, wherein the image capturing control unit acquires the video image that has been captured by the rear camera and that is in the second range.

8. The record and replay control device according to claim 1, wherein
the range identification unit identifies the first range that is to be displayed on a digital inner mirror of the vehicle with respect to the video image acquired by the image capturing control unit, and
the display control unit displays the information that indicates a range displayed on the digital inner mirror of the vehicle on the video image.

9. A replay control method that is executed by a replay device, the replay control method comprising:
a replay control step of replaying a video image that has been captured and recorded by a rear camera that captures an image of a rear of a vehicle; and
a display control step of displaying, when the video image replayed at the replay control step is displayed on a first display unit that displays the video image in a first range in order for a driver of the vehicle to check the rear of the vehicle or is displayed on a second display unit that is different from the first display unit in a second range that is larger than the first range, information that indicates the first range on the video image.

10. A non-transitory computer-readable storage medium storing a program causing a computer to execute:
a replay control step of replaying a video image that has been captured and recorded by a rear camera that captures an image of a rear of a vehicle; and
a display control step of displaying, when the video image replayed at the replay control step is displayed on a first display unit that displays the video image in a first range in order for a driver of the vehicle to check the rear of the vehicle or is displayed on a second display unit that is different from the first display unit in a second range that is larger than the first range, information that indicates the first range on the video image.
